(19) United States
(12) Patent Application Publication
(10) Pub. No.: US 2016/0350175 A1
(43) Pub. Date: Dec. 1, 2016

(54) DUPLICATE DATA USING CYCLIC REDUNDANCY CHECK

(71) Applicant: HEWLETT PACKARD ENTERPRISE DEVELOPMENT LP, Houston, TX (US)

(72) Inventors: Siamak Nazari, Fremont, CA (US); Jin Wang, Fremont, CA (US); Srinivasa D Murthy, Fremont, CA (US)

(21) Appl. No.: 15/117,670

(22) PCT Filed: Apr. 30, 2014
(86) PCT No.: PCT/US2014/036045

§ 371 Date: Aug. 9, 2016

(51) Int. Cl. G06F 11/10; G06F 3/06

(52) U.S. Cl. CPC G06F 11/1004; G06F 3/0619; G06F 3/0641; G06F 3/0673

(57) ABSTRACT

In one example implementation according to aspects of the present disclosure, a method may include calculating, by a computing system, a cyclic redundancy check (CRC) value for a received data request. The method may further include translating, by the computing system, the CRC value into a physical page location using a three-level table walk. The method may also include detecting, by the computing system, whether the received data request represents duplicate data by comparing the received data request with a data stored at the physical page location.

### BACKGROUND

The amount and size of electronic data consumers and companies generate and use continues to grow in size and complexity, as does the size and complexity of related applications. In response, data centers housing the growing and complex data and related applications have begun to implement a variety of networking and server configurations to provide storage of and access to the data.

### BRIEF DESCRIPTION OF THE DRAWINGS

The following detailed description references the drawings, in which:

FIGS. 1A and 1B illustrate block diagrams of a computing system for detecting duplicate data using cyclic redundancy check and three-level table according to examples of the present disclosure;

FIG. 2 illustrates a block diagram of a three-level page table scheme according to examples of the present disclosure;

FIG. 3 illustrates a flow diagram of a method for detecting duplicate data using cyclic redundancy check and three-level table according to examples of the present disclosure; and

FIG. 4 illustrates a flow diagram of a method for detecting duplicate data using cyclic redundancy check and three-level table according to examples of the present disclosure.

### DETAILED DESCRIPTION

As users generate and consume greater amounts of data, the storage demands for these data also increase. Larger volumes of data become increasingly expensive, time consuming, and space consuming to store and access. Moreover, the amount of duplicate data, that is, data that is the same as previously existing data, is common. Such duplicate data further taxes storage resources.

Data deduplication (i.e., detecting duplicate data) in primary storage arrays is increasingly useful with the addition of solid state disks (SSDs) to the supported media in these arrays. The cost differential between SSDs and traditional hard disk drives utilizes solutions like deduplication and compression to reduce the cost per byte of these storage arrays. Primary storage arrays demand the high performance placed on them by host operating systems in terms of low latency and high throughput.

With storage capacities growing increasingly larger, finding duplicate data is a scaling problem that places demands on the central processing unit (CPU) and memory of the storage controllers. The impact of deduplication on input/output performance is determined by various parameters, such as whether data is deduplicated inline or in the background as well as the granularity of deduplication. Deduplicating data at a smaller granularity (such as 16 KB pages), while providing better space savings, requires an increase in CPU processing and memory. Some primary storage arrays are not able to deal with the conflicting demands of input/output performance with inline data deduplication, and consequently resort to background deduplication. Some arrays also address deduplication by deduplicating data in larger chunks (multiple gigabytes). In other examples, data duplication was detected, for example, using cryptographic hashes to determine duplicate data. These cryptographic hashes utilize more space to store and more processing resources to compare.

Deduplication in the computing environment can be performed at many layers, including the server, storage and backup solutions. However, many of the existing solutions are CPU and memory intensive, and do not employ hardware offload engines.

Various implementations are described below by referring to several examples of detecting duplicate data blocks using cyclic redundancy check and three-level table. In one example implementation according to aspects of the present disclosure, a method may include calculating, by a computing system, a cyclic redundancy check (CRC) value for a received data request. The method may further include translating, by the computing system, the CRC value into a physical page location using a three-level table. The method may also include detecting, by the computing system, whether the received data request represents duplicate data by comparing the received data request with a data stored at the physical page location.

In another example implementation according to aspects of the present disclosure, a system may include a processing resource. The system may also include a cyclic redundancy check module to calculate a cyclic redundancy check value of a received data page. Further, the system may include a three-level table module to translate the cyclic redundancy check value into a physical page location of a storage volume. The system may also include a deduplication detection module to determine whether the received data page matches an existing data page in the storage volume by performing an XOR operation and a zero detection operation.

In yet another example, a non-transitory computer-readable storage medium stores instructions that, when executed by a processor, cause the processor to perform the following functions; calculate a cyclic redundancy check (CRC) value for a received data page for a data store; apply the computed CRC value as a page offset into a deduplicate data store; translate the CRC value into a physical page location of the deduplicate data store; and detect duplicate data by determining whether an existing data page at the physical page location matches the received data page.

In some implementations, the described data duplication detection uses less storage space for detecting the duplicate data blocks than conventional cryptographic hashes. For example, by using cyclic redundancy check (CRC) as a first pass for determining duplicate data, the low incidence of CRC collisions (i.e., differing data with the same CRC value), the space utilized in storing hashes is greatly reduced. Conventional cryptographic hashes may use, for example, four to five times as much space for storing the hashes as compared to the CRC values. Additionally, the time needed to make the CRC value comparisons is reduced. These and other advantages will be apparent from the description that follows.

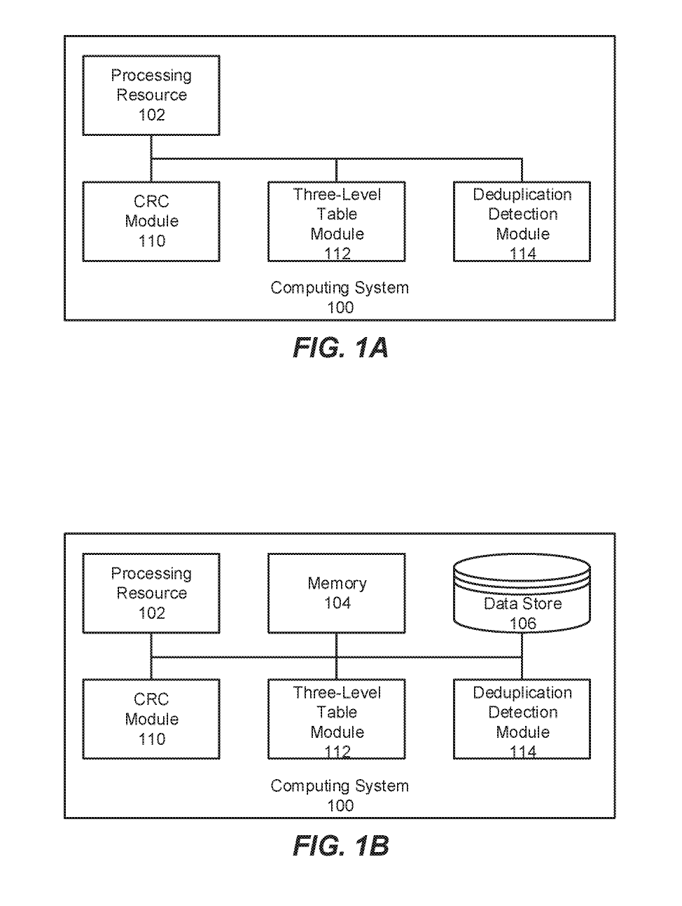

FIGS. 1A and 1B illustrate block diagrams of a computing system 100 for detecting duplicate data using cyclic redundancy check and three-level table according to examples of the present disclosure. FIGS. 1A and 1B include particular components, modules, etc. according to various examples. However, in different implementations, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

It should be understood that the computing device 100 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

The computing system 100 may include a processing resource 102 that represents generally any suitable type or form of processing unit or units capable of processing data or interpreting and executing instructions. The instructions may be stored on a non-transitory tangible computer-readable storage medium, such as memory resource 104 of FIG. 1B, or on a separate device (not shown), or on any other type of volatile or non-volatile memory that stores instructions to cause a programmable processor to perform the techniques described herein. Alternatively or additionally, the computing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

In examples, as illustrated in FIG. 1B, the computing system 100 includes a storage device or array of storage devices, such as data store 106, which may store data including an operating system or operating systems. Certain operating systems provide the ability to configure various virtual volumes on the data store 106 and distribute the virtual volumes across multiple systems. Host may access these volumes using, for example, SCSI commands, providing a LUN identifier, a logical block address (LBA), and a length of an input/output (I/O) operation. In some implementations, a volume type may be a thin provisioned volume—that is, a virtual volume created using a process for optimizing utilization of available storage using on-demand allocation of blocks of data versus the traditional method of allocating the blocks initially. In the case of thin provisioned volumes, data being accessed by a host is located using a three-level page table translation mechanism.

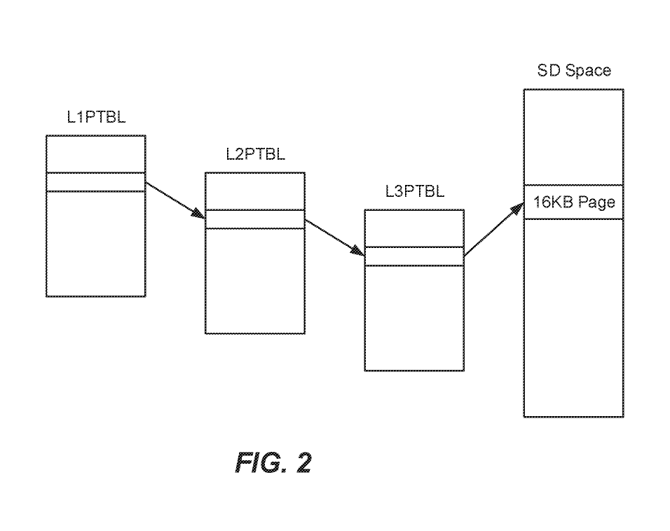

FIG. 2 illustrates a block diagram of a three-level table scheme according to examples of the present disclosure. In an example, such as shown in FIG. 2, the thin provisioned volumes use 16 kilobyte allocation units, although other sizes may be utilized in different examples. These allocation units may use standard file system techniques, such as bitmaps and three-level block pointers. Input/output data requests targeted to a thin provisioned volume is translated by looking up the region in the volume to see if the area being written or read has previously been written. A “write” request to a region that has not been previously written may allocate backing storage and associate it with a virtual address of the thin provisioned volume. In the example shown in FIG. 2, the granularity of the three-level page lookup and allocation is 16 KB. In this example, the space of the thin provisioned volume is represented using a three-level page table system, referred to as L1PTBL, L2PTBL, and L3PTBL. The first and second tables (L1PTBL and L2PBTL) contain pointers to the next level page tables. For example, L1PTBL contains a pointer to a location at L2PTBL, and L2PTBL contains a pointer to a location at L3PTBL. The level three page table (L3PTBL) contains pointers to actual disk pages that provide the 16 KB of backing store for the corresponding virtual thin provisioned volume offset.

Returning to FIG. 1, the computing system 100 may additionally include a cyclic redundancy check (CRC) module 110, a three-level table module 112, and a duplication detection module 114. In one example, the modules described herein may be a combination of hardware and programming. The programming may be processor executable instructions stored on a tangible memory resource such as memory resource 104 of FIG. 1B, and the hardware may include processing resource 102 for executing those instructions. Thus memory resource 104 of FIG, 1B, for example, can be said to store program instructions that when executed by the processing resource 102 implement the modules described herein. Other modules may also be utilized as will be discussed further below in other examples.

The CRC module 110 calculates a cyclic redundancy check value or signature of a received data request in order to aid in locating the data on the physical volume (e.g., the data store 106). For example, when an input/output (I/O) request is received, such as data or a data page, the CRC module 110 calculates a CRC value (or signature) of the incoming data. Once the CRC value (or signature) of the incoming data request is calculated by the CRC module 110, the CRC value is compared to the CRC value of existing data already stored in a storage array (such as data store 106 of FIG. 1B). If a match between the CRC values is identified (that is, a match between the calculated CRC value of the incoming data request and the CRC value existing data already stored in the storage array), the data may be deduplicable in some situations. However, if the CRC value is new (i.e., there is no match between the CRC values), the data is stored in an area for potentially duplicate blocks of data, and its location is stored in a three-level table, which is indexed by CRC.

In examples, the CRC module 110 may be a dedicated hardware module or offload engine that can compute the CRC of the received data request using, for example, the CRC32 algorithm. In other examples, the dedicated hardware module implementation of the CRC module 110 may compute the CRC value using higher precision hashes of data, such as the SHA-2 algorithm. Consequently, by offloading the traditionally processing resource intensive CRC value calculations to a dedicated hardware module, the processing resource (such as processing resource 102) is relived of performing the processing intensive calculations.

Once the value or signature of the incoming data is computed by the CRC module 110, the data is checked to see whether the same signature already exist in the volume receiving the data. In examples, this may also be offloaded to a dedicated hardware module or offload engine. At this point, the three-level table module 112 translates the CRC value into a physical page location or logical block address by performing a three-level table walk. In an example, a hidden thin provisioned volume referred to as a deduplicate data store that is not visible to users may be created.

When a page of data is received and the CRC value is computed for that page, the computed CRC is used as the page offset into the deduplicate data store thin provision volume. Since the deduplicate data store is a thin provision volume, a three-level translation, known as a three-level table walk, may be performed to translate the CRC value into a physical page location.

For the thin provisioned volumes, the data being accessed by the host is located using the three-level table module 112. This translation process is analogous to the way processors translate virtual addresses to physical addresses. The result of translating the host supplied logical block address (LBA) using the three-level page tables is a pointer to a 16KB page, for example, which contains the requested data. Thus, performing the three-level page table walk to translate a CRC value into a physical location pointer is a part of the I/O path in the operating system.

The three-level table walk results in either a physical page location or a null address, which implies that the offset has not been written. Thus, when the CRC value is used to walk the deduplicate data store, it can be determined by the deduplication detection module 114 whether another page within the deduplicate data store exists with the same CRC value.

If another page within the deduplicate data store does not exist, the incoming data request is written to that offset However, if a page does exist, an “exclusive or” (XOR) operation is performed between the new data page and the existing data page. Then, the three-level table module 112 performs a zero detection on the result of the XOR to determine whether the two data pages with the same signature are identical or different. If they are identical, the reference count on the page of data in the deduplicate data store is incremented. However, if they are not identical, a CRC collision is said to occur, and the page is stored in the data store 106 to which the original input/ouput data request was directed. In this way, two pages with identical signatures can be determined to be identical. In example, the three-level table module 112 may utilize special hardware, such as an application specific integrated circuit (ASIC) or other appropriate discrete hardware component to perform the XOR operation and/or the zero detection.

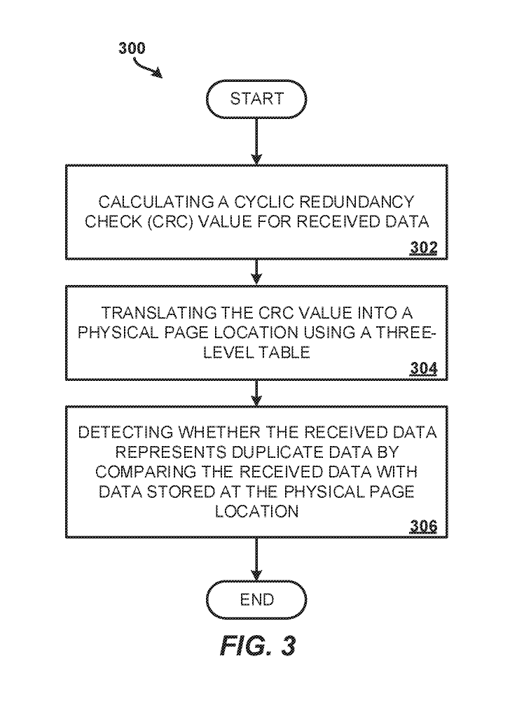

FIG. 3 illustrates a flow diagram of a method 300 for detecting duplicate data using cyclic redundancy check and three-level table according to examples of the present disclosure. The method 300 may be executed by a computing system or a computing device such as computing system 100 of FIG. 1 or may be stored as instructions on a non-transitory computer-readable storage medium that, when executed by a processor, cause the processor to perform the method 300. In one example, the method 300 may include: calculating, by a computing system, a cyclic redundancy check (CRC) value for a received data request (block 302); translating, by the computing system, the CRC value into a physical page location using a three-level table (block 304); and detecting, by the computing system, whether the received data request represents duplicate data by comparing the received data request with a data stored at the physical page location (block 306).

At block 302, the method 300 includes calculating a cyclic redundancy check (CRC) value for received data. For example, the method 300 may include calculating, by a computing system such as computing system 100 of FIG. 1, a cyclic redundancy check (CRC) value for a received data request. When an input/output (I/O) request is received, such as a data page, the CRC value is calculated, such as by the CRC module 110 of FIG. 1. Once the CRC value (or signature) of the incoming data request is calculated, the CRC value may be compared to the CRC value of existing data already stored in a storage array. If a match between the CRC values is identified (that is, a match between the calculated CRC value of the incoming data request and the CRC value existing data already stored in the storage array), the data may be deduplicable in some situations. However, if the CRC value is new (i.e., there is no match between the CRC values) the data is stored in an area for potentially duplicate blocks of data, and its location is stored in a three-level table, which is indexed by CRC. Calculating the cyclic redundancy check value may be performed, for example, by a discrete hardware component, such as an application-specific integrated circuit. The method continues at block 304.

At block 304, the method 300 includes translating the CRC value into a physical page location using a three-level table. For example, the method 300 may include translating, by the computing system such as computing system 100 of FIG, 1, the CRC value into a physical page location using a three-level table as in FIG. 2, The three-level table walk results in either a physical page location or a null address, which implies that the offset has not been written. Thus, when the CRC value is used to walk the deduplicate data store, it can be determined whether another page within the deduplicate data store exists with the same CRC value, The result of translating the host supplied logical block address (LBA) using the three-level page tables is a pointer to a 16KB page, for example, which contains the requested data. Thus, performing the three-level page table walk to translate a CRC value into a physical location pointer is a part of the I/O path in the operating system. The three-level table walk may be performed, for example, by a discrete hardware component, such as an application-specific integrated circuit. The method continues at block 306.

At block 306, the method 300 includes detecting whether the received data represents duplicate data by comparing the received data with data stored at the physical page location. For example, the method 300 may include detecting, by the computing system such as the computing system 100 of FIG. 1, whether the received data request represents duplicate data by comparing the received data request with a data stored at the physical page location.

If another page (i.e., an existing data page) within the deduplicate data store does not exist, the incoming data request is written to that offset. However, if a page does exist, an “exclusive or” (XOR) operation is performed between the new data page and the existing data page. Then a zero detection is performed on the result of the XOR to determine whether the two data pages with the same signature are identical or different. If they are identical, the reference count on the page of data in the deduplicate data store is incremented. However, if they are not identical, a CRC collision is said to occur, and the page is stored in the data store to which the original input/ouput data request was directed. In this way, two pages with identical signatures can be determined to be identical. In example, special hardware, such as an application specific integrated circuit (ASIC) or other appropriate discrete hardware component may be implemented to perform the XOR operation and/or the zero detection.

Additional processes also may be included, and it should be understood that the processes depicted in FIG. 3 represent illustrations, and that other processes may be added or existing processes may be removed, modified, or rearranged without departing from the scope and spirit of the present disclosure.

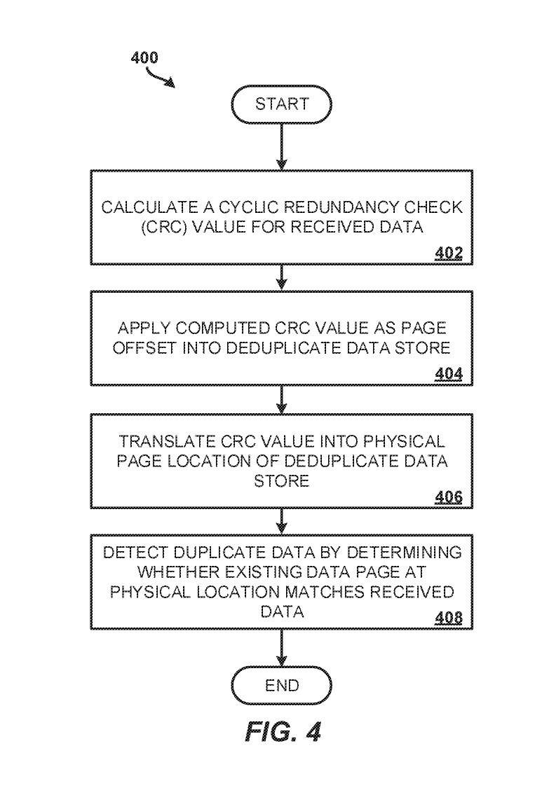

FIG. 4 illustrates a flow diagram of a method 400 for detecting duplicate data using cyclic redundancy check and three-level table according to examples of the present disclosure. The method 400 may be executed by a computing system or a computing device such as computing system 100 of FIG. 1 or may be stored as instructions on a non-transitory computer-readable storage medium that, when executed by a processor, cause the processor to perform the method 400. In one example, the method 400 may include: calculate a cyclic redundancy check (CRC) value for a received data page for a data store (block 402); apply the computed CRC value as a page offset into a deduplicate data store (block 404); translate the CRC value into a physical page location of the deduplicate data store (block 406); and detect duplicate data by determining whether an existing data page at the physical page location matches the received data page (block 408).

At block 402, the method 400 includes calculating a cyclic redundancy check (CRC) value for received data. For example, the method 400 may include calculating a cyclic redundancy check (CRC) value for a received data page for a data store. When an input/output (I/O) request is received, such as a data page, the CRC value is calculated, such as by the CRC module 110 of FIG. 1. Once the CRC value (or signature) of the incoming data request is calculated, the CRC value may be compared to the CRC value of existing data already stored in a storage array. If a match between the CRC values is identified (that is, a match between the calculated CRC value of the incoming data request and the CRC value existing data already stored in the storage array), the data may be deduplicable in some situations. However, if the CRC value is new (i.e., there is no match between the CRC values), the data is stored in an area for potentially duplicate blocks of data, and its location is stored in a three-level table, which is indexed by CRC. Calculating the cyclic redundancy check value may be performed, for example, by a discrete hardware component, such as an application-specific integrated circuit. The method continues at block 404.

At block 404, the method 400 includes applying the computed CRC value as a page offset. For example, the method 400 may include applying the computed CRC value as a page offset into a deduplicate data store. When a page of data is received and the CRC value is computed for that page, the computed CRC is used as the page offset into the deduplicate data store thin provision volume. Since the deduplicate data store is a thin provision volume, a three-level translation, known as a three-level table walk, may be performed to translate the CRC value into a physical page location. The method continues at block 406.

At block 406, the method 400 includes translating the CRC value into a physical page location. For example, the method 400 may include translating the CRC value into a physical page location of the deduplicate data store. The result of translating the host supplied logical block address (LBA) using the three-level page tables is a pointer to a 16KB page, for example, which contains the requested data. Thus, performing the three-level page table walk to translate a CRC value into a physical location pointer is a part of the I/O path in the operating system.

The three-level table walk results in either a physical page location or a null address, which implies that the offset has not been written. Thus, when the CRC value is used to walk the deduplicate data store, it can be determined whether another page within the deduplicate data store exists with the same CRC value. The three-level table walk may be performed, for example, by a discrete hardware component, such as an application-specific integrated circuit. The method continues at block 408.

At block 408, the method 400 includes detecting duplicate data. For example, the method 400 may include detect duplicate data by determining whether an existing data page at the physical page location matches the received data page. If another page (i.e., an existing data page) within the deduplicate data store does not exist, the incoming data request is written to that offset. However, if a page does exist, an “exclusive or” (XOR) operation is performed between the new data page and the existing data page. Then a zero detection is performed on the result of the XOR to determine whether the two data pages with the same signature are identical or different. If they are identical, the reference count on the page of data in the deduplicate data store is incremented. However, if they are not identical, a CRC collision is said to occur, and the page is stored in the data store to which the original input/ouput data request was directed. In this way, two pages with identical signatures can be determined to be identical. In example, special hardware, such as an application specific integrated circuit (ASIC) or other appropriate discrete hardware component may be implemented to perform the XOR operation and/or the zero detection.

Additional processes also may be included, and it should be understood that the processes depicted in FIG. 4 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A method comprising:
calculating, by a computing system, a cyclic redundancy check (CRC) value for a received data request;
translating, by the computing system, the CRC value into a physical page location using a three-level table walk; and
detecting, by the computing system, whether the received data request represents duplicate data by comparing the received data request with a data stored at the physical page location.

2. The method of claim 1, wherein calculating the cyclic redundancy check value is performed by a first discrete hardware component of the computing system.

3. The method of claim 1, wherein comparing the received data request with a data stored at the physical page location is performed by a second discrete hardware component of the computing system.

4. The method of claim 1, wherein comparing the received data request with a data stored at the physical page location utilizes an XOR operation.

5. The method of claim 1, wherein translating the CRC value into a physical page location using the three-level table walk includes using the CRC value as a logical block address for the three-level table walk.

6. A system comprising:
a processing resource;
a cyclic redundancy check module to calculate a cyclic redundancy check value of a received data page;
a three-level table module to translate the cyclic redundancy check value into a physical page location of a storage volume; and
a deduplication detection module to determine whether the received data page matches an existing data page in the storage volume by performing an XOR operation and a zero detection operation.

7. The system of claim 6, wherein the deduplication detection module increases a reference count on the data page of the storage volume in response to determining that the received data page matches the existing data page in the storage volume.

8. The system of claim 6, wherein the deduplication detection module stores the received data page to the storage volume in response to determining that the received data page does not match the existing data page in the storage volume.

9. The system of claim 6, wherein the cyclic redundancy check module is a discrete hardware component.

10. The system of claim 6, wherein the cyclic redundancy check module is an application specific integrated circuit.

11. The system of claim 6, wherein the deduplication detection module is a discrete hardware component.

12. The system of claim 6, wherein the deduplication detection module is an application specific integrated circuit to perform the XOR operation and the zero detection operation.

13. The system of claim 6, wherein the system a distributed system having a plurality of storage volumes.

14. A non-transitory computer-readable storage medium storing instructions that, when executed by a processor, cause the processor to:
calculate a cyclic redundancy check (CRC) value for a received data page for a data store;
apply the computed CRC value as a page offset into a deduplicate data store;
translate the CRC value into a physical page location of the deduplicate data store; and
detect duplicate data by determining whether an existing data page at the physical page location matches the received data page,

15. The non-transitory computer-readable storage medium of claim 14, wherein determining whether an existing data page at the physical page location matches the received data page by performing an XOR operation and a zero detection operation.
